(19) United States
(12) Patent Application Publication
(10) Pub. No.: US 2005/0233130 A1
(43) Pub. Date: Oct. 20, 2005

(54) Shaped part comprising a laminate panel or laminate film and a supporting layer

(75) Inventors: Achim Grefenstein, Altrip (DE); Michael Breulmann, Mannheim (DE)

Correspondence Address: CONNOLLY BOVE LODGE & HUTZ LLP, SUITE 800, 1990 M STREET NW, WASHINGTON, DC, 20036-3425, US

(73) Assignee: BASF AKTIENGESELLSCHAFT, Ludwigshafen (DE)

(21) Appl. No.: 10/519,190

(22) PCT Filed: Jun. 20, 2003
(86) PCT No.: PCT/EP03/06513

§ 371 Date: Dec. 22, 2004

(30) Foreign Application Priority Data
Jun. 25, 2002 (DE) 102 28 376.1

(51) Int. Cl. B29C 47/06; B32B 5/16

(52) U.S. Cl. 428/323; 264/173.11

(57) ABSTRACT

The invention relates to moldings encompassing a composite layered sheet or composite layered film and a backing layer made from plastic injection-molded, foamed, or cast onto the back of the material, where the composite layered sheet or composite layered film encompasses (1) a substrate layer comprising, based on the total of the amounts of components A and B, and, where appropriate, C and/or D, which give 100% by weight in total, a from 1-99% by weight of an elastomeric graft copolymer as component A, b from 1-99% by weight of one or more hard copolymers containing units which derive from vinylaromatic monomers, as component B, c from 0-80% by weight of polycarbonates, as component C, and d from 0-50% by weight of fibrous or particulate fillers, or a mixture of these, as component D, Wherein component B contains, based us the total weight of units deriving from vinylaromatic monomers, from 40-100% by weight of units deriving from α-methylstyrene and from 0-60% by weight of units deriving from styrene. The invention further relates to a process for producing these moldings, to their use as bodywork components or motor vehicles, and also to motor vehicle bodywork components comprising these moldings.

The invention relates to moldings encompassing a composite layered sheet or composite layered film and a backing layer made from plastic injection-molded, foamed, or cast onto the back of the material, where the composite layered sheet or composite layered film encompasses
(1) a substrate layer comprising, based on the total of the amounts of components A and B, and, where appropriate, C and/or D, which give 100% by weight in total,
   a from 1 to 99% by weight of an elastomeric graft copolymer as component A,
   b from 1 to 99% by weight of one or more hard copolymers containing units which derive from vinylaromatic monomers, as component B,
   c from 0 to 80% by weight of polycarbonates, as component C, and
   d from 0 to 50% by weight of fibrous or particulate fillers, or a mixture of these, as component D.

The invention further relates to a process for producing these moldings, to their use as bodywork components for motor vehicles, and also to motor vehicle bodywork components comprising these moldings.

When plastics are used outdoors, where they are exposed to weathering and in particular UV radiation and the effects of temperature, high requirements are placed upon their UV resistance and weathering resistance. In particular when they are used in external bodywork components in the motor vehicle sector, there are also high requirements placed upon other mechanical properties, such as heat resistance, and also optical quality, such as surface evenness. The moldings and materials used to date do not always comply with these conditions.

Bodywork components made from plastics are top-coated, for example, or bulk-colored and clear-coated. The top coating requires high heat resistance, which only a few plastics can provide. Bulk coloration, in particular using special-effect pigments, is very costly and often impairs the mechanical properties of the substrate.

Instead of spray-coating it is possible to use other coating methods, such as in-mold coating technology. This produces coating films by roller-coating or intaglio imprinting methods, and applies backing materials to the reverse of these by injection molding or compression molding. EP-B1-0 361 823 describes films of this type composed of fluoropolymers or of mixtures of these with acrylates. Curable polyester compositions reinforced with fillers are applied to the back of these materials by compression molding. The layers may also comprise acrylonitrile-butadiene-styrene copolymers (ABS).

There are also known coextruded sheets made from polymethyl methacrylate (PMMA) and ABS and used as bodywork material. For example, H. Kappacher, in Kunststoffe 86 (1996), pp. 388-392 describes coextruded PMMA/ABS composite sheets. The bodywork components here are produced by coextruding via a slot die to give sheets, and then thermoforming the sheets. The coextrusion process using a slot die is described by way of example in EP-A2-0 225 500.

EP-A2 847 852 also discloses composite layered sheets or composite layered films the back of which has been coated by injection molding. These sheets or films encompass layers made from acrylate-styrene-acrylonitrile copolymers (ASA) and PMMA. Processes for producing these composite layered sheets or composite layered films are also described, as is their use in the motor vehicle sector.

These known composite layered sheets or composite layered films to the back of which material has been applied by injection molding and which are composed of PMMA/ABS or ASA/PMMA have the disadvantage that, although they have good heat resistances at high temperatures, their surface quality is often inadequate, an example being a high degree of unevenness. This disadvantage is in particular often apparent when the polymer applied to the back of the material by injection molding, casting, or foaming has a porous structure or an open-cell or closed-cell foam structure, or when the material develops a compact or consolidated structure but the form in which this is present is that of a honeycomb or ribs or struts injection-molded onto the material. Although this disadvantage can be reduced by using thicker composite layered sheets or composite layered films, this is undesirable for reasons of weight and cost.

It is an object of the present invention to provide moldings encompassing a composite layered sheet or composite layered film and a backing layer made from plastic injection-molded, foamed, or cast onto the back of the material, these moldings having improved surface quality at high temperatures, in particular less unevenness, than known moldings but comparable thickness of the composite layered sheet or composite layered film.

According to the invention this object is achieved by way of moldings encompassing a composite layered sheet or composite layered film and a backing layer made from plastic injection-molded, foamed, or cast onto the back of the material, where the composite layered sheet or composite layered film encompasses
(1) a substrate layer comprising, based on the total of the amounts of components A and B, and, where appropriate, C and/or D, which give 100% by weight in total,
   a from 1 to 99% by weight of an elastomeric graft copolymer as component A,
   b from 1 to 99% by weight of one or more hard copolymers containing units which derive from vinylaromatic monomers, as component B,
   c from 0 to 80% by weight of polycarbonates, as component C, and
   d from 0 to 50% by weight of fibrous or particulate fillers, or a mixture of these, as component D,
   wherein component B contains, based on the total weight of units deriving from vinylaromatic monomers, from 40 to 100% by weight of units deriving from α-methylstyrene and from 0 to 60% by weight of units deriving from styrene.

The moldings of the invention have better surface quality at high temperatures, in particular less unevenness, than the known moldings at comparable thickness of the composite layered sheet or composite layered film. They are therefore particularly suitable for outdoor use where they are exposed to the effects of weathering, high temperatures, and insolation. In particular, they can be used in the motor vehicle sector.

The individual layers or components of the moldings and the composite layered sheets or composite layered films composed of these are described below.

Layer (1)

Layer (1) is composed of the following components A and B and, where appropriate, C and/or D, the entirety of which gives 100% by weight.

The substrate layer (1) comprises impact-modified copolymers of vinylaromatic monomers with vinyl cyanides (SAN), and also, where appropriate, comprises other components. It is important for the invention that, based on the total weight of units deriving from vinylaromatic monomers, the SAN contains from 40 to 100% by weight of units deriving from α-methylstyrene and from 0 to 60% by weight of units deriving from styrene.

The impact-modified SAN used is preferably ASA polymers and/or ABS polymers.

ASA polymers are generally understood to mean impact-modified SAN polymers in which graft copolymers of vinylaromatic compounds, in particular styrene, with vinyl cyanides, in particular acrylonitrile, are present on polyalkyl acrylate rubbers in a copolymer matrix in particular of styrene and/or α-methylstyrene and acrylonitrile.

In one preferred embodiment in which the substrate layer (1) encompasses ASA polymers, component A is an elastomeric graft copolymer made from
a1 from 1 to 99% by weight, preferably from 55 to 80% by weight, in particular from 55 to 65% by weight, of a particulate graft base A1 with a glass transition temperature below 0° C.,
a2 from 1 to 99% by weight, preferably from 20 to 45% by weight, in particular from 35 to 45% by weight, of a graft A2 made from the following monomers, based on A2,
a21 from 40 to 100% by weight, preferably from 65 to 85% by weight, of units of styrene, of a substituted styrene, or of a (meth)acrylate, or of a mixture of these, in particular of styrene and/or α-methylstyrene, as component A21, and
a22 up to 60% by weight, preferably from 15 to 35% by weight, of units of acrylonitrile or methacrylonitrile, in particular of acrylonitrile, as component A22.

The graft A2 here is composed of at least one graft shell, and the graft copolymer A has a total median particle size of from 50 to 1000 nm.

Component A1 here is composed of the following monomers
a11 from 80 to 99.99% by weight, preferably from 95 to 99.9% by weight, of at least one C₁-C₈-alkyl acrylate, preferably n-butyl acrylate and/or ethylhexyl acrylate, as component A11,
a12 from 0.01 to 20% by weight, preferably from 0.1 to 5.0% by weight, of at least one polyfunctional crosslinking monomer, preferably diallyl phthalate and/or DCPA, as component A12.

In one embodiment of the invention, the median particle size of component A is from 50 to 800 nm, preferably from 50 to 600 nm.

In another embodiment of the invention, the particle size distribution of component A is bimodal, from 60 to 90% by weight having a median particle size of from 50 to 200 nm, and from 10 to 40% by weight having a median particle size of from 50 to 400 nm, based on the total weight of component A.

The median particle size and particle size distribution given are the sizes determined from the cumulative weight distribution. The median particle sizes according to the invention are in all cases the weight average of the particle sizes. The determination of these is based on the method of W. Scholtan and H. Lange, Kolloid-Z. und Z.-Polymere 250 (1972), pp. 782-796, using an analytical ultracentrifuge. The ultracentrifuge measurement gives the cumulative weight distribution of the particle diameter of a specimen. From this it is possible to deduce what percentage by weight of the particles have a diameter identical to or smaller than a particular size. The median particle diameter, which is also termed the d₅₀ of the cumulative weight distribution, is defined here as that particle diameter at which 50% by weight of the particles have a diameter smaller than that corresponding to the d₅₀. Equally, 50% by weight of the particles then have a larger diameter than the d₅₀. To describe the breadth of the particle size distribution of the rubber particles, d₁₀ and d₉₀ values given by the cumulative weight distribution are utilized alongside the d₅₀ value (median particle diameter). The d₁₀ and d₉₀ of the cumulative weight distribution are defined similarly to the d₅₀ with the difference that they are based on, respectively, 10 and 90% by weight of the particles. The quotient

$$\frac{{d}_{90} - {d}_{10}}{{d}_{50}} = Q$$

is a measure of the breadth of the particle size distribution. Emulsion polymers A which can be used according to the invention as component A preferably have Q less than 0.5, in particular less than 0.35.

The acrylate rubbers A1 are preferably alkyl acrylate rubbers made from one or more C₁-C₈-alkyl acrylates, preferably C₄-C₈-alkyl acrylates, preferably with use of at least some butyl, hexyl, octyl or 2-ethylhexyl acrylate, in particular n-butyl and 2-ethylhexyl acrylate. These alkyl acrylate rubbers may contain, as comonomers, up to 30% by weight of hard-polymer-forming monomers, such as vinyl acetate, (meth)acrylonitrile, styrene, substituted styrene, methyl methacrylate, vinyl ether.

The acrylate rubbers also contain from 0.01 to 20% by weight, preferably from 0.1 to 5% by weight, of crosslinking, polyfunctional monomers (crosslinking monomers). Examples of these are monomers which contain two or more double bonds capable of copolymerization, preferably not 1,3-conjugated.

Examples of suitable crosslinking monomers are divinylbenzene, diallyl maleate, diallyl fumarate, diallyl phthalate, diethyl phthalate, triallyl cyanurate, triallyl isocyanurate, tricyclodecenyl acrylate, dihydrodicyclopentadienyl acrylate, triallyl phosphate, allyl acrylate, allyl methacrylate. Dicyclopentadienyl acrylate (DCPA) has proven to be a particularly suitable crosslinking monomer (cf. DE-C 12 60 135).

Component A is a graft copolymer. These graft copolymers A have a median particle size d₅₀ of from 50 to 1000 nm, preferably from 50 to 800 nm, and particularly preferably from 50 to 600 nm. These particle sizes may be achieved if the graft base A1 used for this component A has a particle size of from 50 to 350 nm, preferably from 50 to 300 nm, and particularly preferably from 50 to 250 nm.

The graft copolymer A generally has one or more stages, i.e. is a polymer composed of a core and one or more shells. The polymer is composed of a first stage (graft core) A1 and of one or—preferably—more stages A2 (grafts) grafted onto this first stage and known as graft stages or graft shells.

Simple grafting or multiple stepwise grafting may be used to apply one or more graft shells to the rubber particles, and each of these graft shells may have a different makeup. In addition to the monomers to be grafted, polyfunctional crosslinking monomers or monomers containing reactive groups may also be included in the grafting (see, for example, EP-A 230 282, DE-B 36 01 419, EP-A 269 861).

In one preferred embodiment, component A is composed of a graft copolymer built up in two or more stages, the graft stages generally being prepared from resin-forming monomers and having a glass transition temperature T_{g} above 30° C., preferably above 50° C. The structure having two or more stages serves, inter alia, to make the rubber particles A (partially) compatible with the thermoplastic B.

An example of a preparation method for graft copolymers A is grafting of at least one of the monomers A2 listed below onto at least one of the graft bases or graft core materials A1 listed above.

In one embodiment of the invention, the graft base A1 is composed of from 15 to 99% by weight of acrylate rubber, from 0.1 to 5% by weight of crosslinker, and from 0 to 49.9% by weight of one of the stated other monomers or rubbers.

Suitable monomers for forming the graft A2 are styrene, α-methylstyrene, (meth)acrylates, acrylonitrile, and methacrylonitrile, in particular acrylonitrile.

In one embodiment of the invention, crosslinked acrylate polymers with a glass transition temperature below 0° C. serve as graft base A1. The crosslinked acrylate polymers are preferably to have a glass transition temperature below −20° C., in particular below −30° C.

In one preferred embodiment, the graft A2 is composed of at least one graft shell, and the outermost graft shell of these has a glass transition temperature of more than 30° C., while a polymer formed from the monomers of the graft A2 would have a glass transition temperature of more than 80° C.

Suitable preparation processes for graft copolymers A are emulsion, solution, bulk, or suspension polymerization. The graft copolymers A are preferably prepared by free-radical emulsion polymerization in the presence of lattices of component A1 at from 20° C. to 90° C., using water-soluble or oil-soluble initiators, such as peroxodisulfate or benzoyl peroxide, or with the aid of redox initiators. Redox initiators are also suitable for polymerization below 20° C.

Suitable emulsion polymerization processes are described in DE-A 28 26 925, 31 49 358, and DE-C 12 60 135.

The graft shells are preferably built up in the emulsion polymerization process described in DE-A 32 27 555, 31 49 357, 31 49 358, 34 14 118. The defined setting of the particle sizes of the invention of from 50 to 1000 nm preferably takes place by the processes described in DE-C 12 60 135 and DE-A 28 26 925, and Applied Polymer Science, volume 9 (1965), p. 2929. The use of polymers with different particle sizes is known from DE-A 28 26 925 and U.S. Pat. No. 5,196,480, for example.

The process described in DE-C 12 60 135 begins by preparing the graft base A1 by polymerizing in a known manner, at from 20 to 100° C., preferably from 50 to 80° C., the acrylate(s) used in one embodiment of the invention and the polyfunctional crosslinking monomer, where appropriate together with the other comonomers, in aqueous emulsion. Use may be made of the usual emulsifiers, such as alkali metal alkyl- or alkylarylsulfonates, alkyl sulfates, fatty alcohol sulfonates, salts of higher fatty acids having from 10 to 30 carbon atoms or resin soaps. It is preferable to use the sodium salts of alkylsulfonates or fatty acids having from 10 to 18 carbon atoms. In one embodiment, the amounts used of the emulsifiers are from 0.5 to 5% by weight, in particular from 1 to 2% by weight, based on the monomers used in preparing the graft base A1. Operations are generally carried out with a ratio of water to monomers of from 2:1 to 0.7:1 by weight. The polymerization initiators used are in particular the commonly used persulfates, such as potassium persulfate. However, it is also possible to use redox systems. The amounts generally used of the initiators are from 0.1 to 1% by weight, based on the monomers used in preparing the graft base A1. Other polymerization auxiliaries which may be used during the polymerization are the usual buffer substances which can set a preferred pH of from 6 to 9, examples being sodium bicarbonate and sodium pyrophosphate, and also from 0 to 3% by weight of a molecular weight regulator, such as mercaptans, terpinols or dimeric α-methylstyrene.

The precise polymerization conditions, in particular the nature, feed parameters, and amount of the emulsifier, are determined individually within the ranges given above in such a way that the resultant latex of the crosslinked acrylate polymer has a d₅₀ in the range from about 50 to 1000 nm, preferably from 50 to 600 nm, particularly preferably in the range from 80 to 500 nm. The particle size distribution of the latex here is intended to be narrow.

In a subsequent step, polymerization of a monomer mixture made from styrene and acrylonitrile in the presence of the resultant latex of the crosslinked acrylate polymer in one embodiment of the invention is carried out to prepare the graft polymer A, where in one embodiment of the invention the weight ratio of styrene to acrylonitrile in the monomer mixture should be in the range from 100:0 to 40:60, and preferably from 65:35 to 85:15. This graft copolymerization of styrene and acrylonitrile onto the crosslinked polyacrylate polymer serving as a graft base is again advantageously carried out in aqueous emulsion under the usual conditions described above. The graft copolymerization may usefully take place in the system used for the emulsion polymerization to prepare the graft base A1, where further emulsifier and initiator may be added if necessary. The mixture of styrene and acrylonitrile monomers which is to be grafted on in one embodiment of the invention may be added to the reaction mixture all at once, in portions in more than one step, or preferably continuously during the course of the polymerization. The graft copolymerization of the mixture of styrene and acrylonitrile in the presence of the crosslinking acrylate polymer is carried out in such a way as to obtain in graft copolymer A a degree of grafting of from 1 to 99% by weight, preferably from 20 to 45% by weight, in particular from 35 to 45% by weight, based on the total weight of component A. Since the grafting yield in the graft copolymerization is not 100% the amount of the mixture of styrene and acrylonitrile monomers which has to be used in the graft copolymerization is somewhat greater than that which corresponds to the desired degree of grafting. Control of the grafting yield in the graft copolymerization, and therefore of the degree of grafting of the finished graft copolymer A, is a topic with which the person skilled in the art is familiar. It may be achieved, for example, via the metering rate of the monomers or via addition of regulators (Chauvel, baniel, ACS Polymer Preprints 15 (1974), pp. 329 ff.). The emulsion graft copolymerization generally gives approximately 5 to 15% by weight, based on the graft copolymer, of free, ungrafted styrene-acrylonitrile copolymer. The proportion of the graft copolymer A in the polymerization product obtained in the graft copolymerization is determined by the method given above.

Preparation of the graft copolymers A by the emulsion process also gives, besides the technical process advantages stated above, the possibility of reproducible changes in particle sizes, for example by agglomerating the particles at least to some extent to give larger particles. This implies that polymers with different particle sizes may also be present in the graft copolymers A.

Component A made from graft base and graft shell(s) can in particular be ideally adapted to the respective application, in particular with regard to particle size.

The graft copolymers A generally comprise from 1 to 99% by weight, preferably from 55 to 80% by weight, and particularly preferably from 55 to 65% by weight, of graft base A1 and from 1 to 99% by weight, preferably from 20 to 45% by weight, particularly preferably from 35 to 45% by weight, of the graft A2, based in each case on the entire graft copolymer.

ABS polymers are generally understood to be impact-modified SAN polymers in which diene polymers, in particular poly-1,3-butadiene, are present in a copolymer matrix, in particular of styrene and/or α-methylstyrene, and acrylonitrile.

In one preferred embodiment, in which the substrate layer (1) encompasses ABS polymers, component A is an elastomeric graft copolymer made from
a1′ from 10 to 90% by weight of at least one elastomeric graft base with a glass transition temperature below 0° C., obtainable by polymerizing, based on A1′,
a11′ from 60 to 100% by weight, preferably from 70 to 100% by weight, of at least one conjugated diene and/or C₁-C₁₀-alkyl acrylate, in particular butadiene, isoprene, n-butyl acrylate and/or 2-ethylhexyl acrylate,
a12′ from 0 to 30% by weight, preferably from 0 to 25% by weight, of at least one other monoethylenically unsaturated monomer, in particular styrene, α-methylstyrene, n-butyl acrylate, methyl methacrylate, or a mixture of these, and
a13′ from 0 to 10% by weight, preferably from 0 to 6% by weight, of at least one crosslinking monomer, preferably divinylbenzene, diallyl maleate, allyl(meth)acrylate, dihydrodicyclopentadienyl acrylate, divinyl esters of dicarboxylic acids, such as succinic and adipic acid, and diallyl and divinyl ethers of bifunctional alcohols, such as ethylene glycol or butane-1,4-diol,
a2′ from 10 to 60% by weight, preferably from 15 to 55% by weight, of a graft A2′, made from, based on A2′,
a21′ from 50 to 100% by weight, preferably from 55 to 90% by weight, of at least one vinylaromatic monomer, preferably styrene and/or α-methylstyrene,
a22′ from 5 to 35% by weight, preferably from 10 to 30% by weight, of acrylonitrile and/or methacrylonitrile, preferably acrylonitrile,
a23′ from 0 to 50% by weight, preferably from 0 to 30% by weight, of at least one other monoethylenically unsaturated monomer, preferably methyl methacrylate and n-butyl acrylate.

In another preferred embodiment in which layer (1) comprises ABS, component A is a graft rubber with bimodal particle size distribution, made from, based on A,
a1″ from 40 to 90% by weight, preferably from 45 to 85% by weight, of an elastomeric particulate graft base A1″, obtainable by polymerizing, based on A1″,
a11″ from 70 to 100% by weight, preferably from 75 to 100% by weight, of at least one conjugated diene, in particular butadiene and/or isoprene,
a12″ from 0 to 30% by weight, preferably from 0 to 25% by weight, of at least one other monoethylenically unsaturated monomer, in particular styrene, α-methylstyrene, n-butyl acrylate, or a mixture of these,
a2″ from 10 to 60% by weight, preferably from 15 to 55% by weight, of a graft A2″ made from, based on A2″,
a21″ from 65 to 95% by weight, preferably from 70 to 90% by weight, of at least one vinylaromatic monomer, preferably styrene,
a22″ from 5 to 35% by weight, preferably from 10 to 30% by weight, of acrylonitrile,
a23″ from 0 to 30% by weight, preferably from 0 to 20% by weight, of at least one other monoethylenically unsaturated monomer, preferably methyl methacrylate and n-butyl acrylate.
   Component B

In one preferred embodiment in which the substrate layer (1) encompasses ASA polymers, component B is at least one hard copolymer which contains units which derive from vinylaromatic monomers, and containing, based on the total weight of units deriving from vinylaromatic monomers, from 40 to 100% by weight, preferably from 50 to 100% by weight, particularly preferably from 60 to 100% by weight, of units deriving from α-methylstyrene, and containing from 0 to 60% by weight, preferably from 0 to 50% by weight, particularly preferably from 0 to 40% by weight, of units deriving from styrene, made from
b1 from 40 to 100% by weight, preferably from 60 to 85% by weight, of vinylaromatic units, as component B1,
b2 up to 60% by weight, preferably from 15 to 40% by weight, of units of acrylonitrile or of methacrylonitrile, in particular of acrylonitrile, as component B2.

In one preferred embodiment, in which the substrate layer (1) encompasses ABS polymers, component B is at least one hard copolymer which contains units which derive from vinylaromatic monomers, and containing, based on the total weight of units deriving from vinylaromatic monomers, from 40 to 100% by weight, preferably from 50 to 100% by weight, particularly preferably from 60 to 100% by weight, of units deriving from α-methylstyrene, and from 0 to 60% by weight, preferably from 0 to 50% by weight, particularly preferably from 0 to 40% by weight, of units deriving from styrene, made from, based on B,
b1′ from 50 to 100% by weight, preferably from 55 to 90% by weight, of vinylaromatic monomers,
b2′ from 0 to 50% by weight of acrylonitrile or methacrylonitrile or a mixture of these,
b3′ from 0 to 50% by weight of at least one other monoethylenically unsaturated monomer, such as methyl methacrylate and N-alkyl- or N-arylmaleimides, e.g. N-phenylmaleimide.

In another preferred embodiment in which layer (1) comprises ABS, component B is at least one hard copolymer with a viscosity number VN (determined to DIN 53726 at 25° C. in 0.5% strength by weight solution in dimethylformamide) of from 50 to 120 ml/g, containing units which derive from vinylaromatic monomers, and containing, based on the total weight of units deriving from vinylaromatic monomers, from 40 to 100% by weight, preferably from 50 to 100% by weight, particularly preferably from 60 to 100% by weight, of units deriving from α-methylstyrene, and from 0 to 60% by weight, preferably from 0 to 50% by weight, particularly preferably from 0 to 40% by weight, of units deriving from styrene, made from, based on B
b1″ from 69 to 81% by weight, preferably from 70 to 78% by weight, of vinylaromatic monomers,
b2″ from 19 to 31% by weight, preferably from 22 to 30% by weight, of acrylonitrile,
b3″ from 0 to 30% by weight, preferably from 0 to 28% by weight, of at least one other monoethylenically unsaturated monomer, such as methyl methacrylate and N-alkyl- or N-arylmaleimides, e.g. N-phenylmaleimide.

In one embodiment, the ABS polymers comprise, alongside one another, components B whose viscosity numbers VN differ by at least 5 units (ml/g) and/or whose acrylonitrile contents differ by at least five units (% by weight). Finally, besides the component B in the other embodiments there may also be copolymers present of α-methylstyrene with maleic anhydride or maleimides, of α-methylstyrene with maleimides and methyl methacrylate or acrylonitrile, or of α-methylstyrene with maleimides, methyl methacrylate, and acrylonitrile.

In the case of these ABS polymers, the graft polymers A are preferably obtained by emulsion polymerization. The mixing of the graft polymers A with components B and, where appropriate, other additives takes place in a mixing apparatus, producing a substantially molten polymer mixture. It is advantageous for the molten polymer mixture to be cooled very rapidly.

The German Patent Application DE-A 19728629, expressly incorporated herein by way of reference, also gives a detailed description of the preparation of the abovementioned ABS polymers and of both general and specific embodiments of these polymers.

The ABS polymers mentioned may comprise other conventional auxiliaries and fillers. Examples of these materials are lubricants, mold-release agents, waxes, pigments, dyes, flame retardants, antioxidants, light stabilizers, and antistats.

In one particular embodiment of the invention, the viscosity number of component B is from 50 to 90, preferably from 60 to 80.

Component B is preferably an amorphous polymer. In one embodiment of the invention, the component B used comprises a mixture of a copolymer of styrene with acrylonitrile and a copolymer of α-methylstyrene with acrylonitrile. The acrylonitrile content in these copolymers of component B is from 0 to 60% by weight, preferably from 15 to 40% by weight, based on the total weight of component B. Component B also includes the free, ungrafted α-methylstyrene-acrylonitrile copolymers produced during the graft copolymerization to prepare component A. Depending on the conditions selected during the graft copolymerization for preparing the graft copolymer A, it can be possible for a sufficient proportion of component B to be formed before the graft copolymerization has ended. However, it is generally necessary to blend the products obtained during the graft copolymerization with additional, separately prepared component B.

This additional separately prepared component B may preferably be a mixture of styrene-acrylonitrile copolymer with an α-methylstyrene-acrylonitrile copolymer, or may be an α-methylstyrene-styrene-acrylonitrile terpolymer. These copolymers may be used for component B either as individual polymers or else as a mixture, and therefore the additional, separately prepared component B may be, for example, a mixture of a styrene-acrylonitrile copolymer with an α-methylstyrene-acrylonitrile copolymer. In the event that component B is composed of a mixture of a styrene-acrylonitrile copolymer with an α-methylstyrene-acrylonitrile copolymer, the acrylonitrile contents of the two copolymers should preferably differ from one another by not more than 10% by weight, preferably not more than 5% by weight, based on the total weight of the copolymer.

The additional, separately prepared component B may be obtained by the conventional processes. In one embodiment of the invention, therefore, the copolymerization of the styrene and/or α-methylstyrene with the acrylonitrile may be carried out in bulk, solution, suspension or aqueous emulsion. Component B preferably has a viscosity number of from 40 to 100, preferably from 50 to 90, in particular from 60 to 80. The viscosity number is determined here in accordance with DIN 53 726, by dissolving 0.5 g of material in 100 ml of dimethylformamide.

Components A and B and, where appropriate, C and D, may be mixed in any desired manner using any of the known methods. If, for example, components A and B have been prepared by emulsion polymerization, the polymer dispersions obtained may be mixed with one another, the polymers then precipitated together and the polymer mixture worked up. However, the blending of components A and B preferably takes place by extruding, kneading or rolling the components together. If required, the components have previously been isolated from the aqueous dispersion or solution obtained in the polymerization. The products of the graft copolymerization (component A) which have been obtained in aqueous dispersion may also be only partly dewatered and mixed in the form of moist crumbs with component B. In this case the complete drying of the graft copolymers takes place during the mixing.

In one preferred embodiment, the layer (1) comprises additional components C and/or D besides components A and B, and also, where appropriate, other additives, as described below.

Component C

In principle, any of the polycarbonates known per se or available commercially is suitable as component C. The polycarbonates suitable as component C preferably have a molar mass (weight average Mw, determined using gel permeation chromatography in tetrahydrofuran against polystyrene standards) in the range from 10 000 to 60 000 g/mol. They are obtainable, for example, by the processes of DE-B-1 300 266 by interfacial polycondensation or by the process of DE-A-1 495 730 by reacting diphenyl carbonate with bisphenols. A preferred bisphenol is 2,2-di(4-hydroxyphenyl)propane, referred to generally, and also below, as bisphenol A.

Instead of bisphenol A use may also be made of other aromatic dihydroxy compounds, in particular 2,2-di(4-hydroxyphenyl)pentane, 2,6-dihydroxynaphthalene, 4,4′-dihydroxydiphenyl sulfane, 4,4′-dihydroxydiphenyl ether, 4,4′-dihydroxydiphenyl sulfone, 4,4′-dihydroxydiphenylmethane, 1,1-di(4-hydroxyphenyl)ethane, 4,4-dihydroxydiphenyl or dihydroxydiphenylcycloalkanes, preferably dihydroxydiphenylcyclohexanes or dihydroxycyclopentanes, in particular 1,1-bis(4-hydroxyphenyl)-3,3,5-trimethylcyclohexane, or also mixtures of the abovementioned dihydroxy compounds.

Particularly preferred polycarbonates are those based on bisphenol A or bisphenol A together with up to 80 mol % of the abovementioned aromatic dihydroxy compounds.

Polycarbonates particularly highly suitable as component C are those containing units which derive from resorcinol esters or from alkylresorcinol esters, for example as described in WO 00/61664, WO 00/15718, or WO 00/26274. Polycarbonates of this type are marketed by General Electric Company with the trademark SollX®, for example.

It is also possible to use copolycarbonates of U.S. Pat. No. 3,737,409. Copolycarbonates based on bisphenol A and di(3,5-dimethyldihydroxyphenyl)sulfone are of particular interest here and have high heat resistance. It is also possible to use mixtures of different polycarbonates.

According to the invention, the average molar masses (weight average M_{W} determined with the aid of gel permeation chromatography in tetrahydrofuran against polystyrene standards) of the polycarbonates C are in the range from 10 000 to 64 000 g/mol. They are preferably in the range from 15 000 to 63 000 g/mol, in particular from 15 000 to 60 000 g/mol. This implies that the polycarbonates C have relative solution viscosities, measured in 0.5% strength by weight solution in dichloromethane at 25° C., in the range from 1.1 to 1.3, preferably from 1.15 to 1.3. The relative solution viscosities of the polycarbonates used preferably do not differ by more than 0.05, in particular not by more than 0.04.

The polycarbonates C may be used either as ground material or as pellets. They are present as component C in amounts of from 0 to 50% by weight, preferably from 10 to 40% by weight, based in each case on the entire molding composition.

Addition of polycarbonates leads, inter alia, to greater thermal stability and improved cracking resistance of the sheets, films, and moldings.

Component D

As component D, layer (1) comprises from 0 to 50% by weight, preferably from 0 to 40% by weight, in particular from 0 to 30% by weight, of fibrous or particulate fillers or a mixture of these, based in each case on the entire layer 1. These are preferably commercially available products.

Reinforcing agents, such as carbon fibers and glass fibers, are usually used in amounts of from 5 to 50% by weight, based on the entire layer (1).

The glass fibers used may be made from E, A or C glass and have preferably been provided with a size and with a coupling agent. Their diameter is generally from 6 to 20 μm. Use may be made either of continuous-filament fibers (rovings) or of chopped glass fibers (staple) whose length is from 1 to 10 mm, preferably from 3 to 6 mm.

It is also possible to add fillers or reinforcing substances such as glass beads, mineral fibers, whiskers, alumina fibers, mica, powdered quartz and wollastonite.

In addition, metal flakes (e.g. aluminum flakes from Transmet Corp.), metal powders, metal fibers, metal-coated fillers, e.g. nickel-coated glass fibers, and also other additives which screen electromagnetic waves, may be added. Aluminum flakes (K 102 from Transmet) are particularly suitable for EMI (electromagnetic interference) purposes. The compositions may also be mixed with additional carbon fibers, carbon black, in particular conductivity black, or nickel-coated carbon fibers.

The layer (1) used according to the invention may moreover comprise other additives which are typical and commonly used for polycarbonates, SAN polymers, and graft copolymers, or for mixtures of these. Examples which may be mentioned of these additives are: dyes, pigments, colorants, antistats, antioxidants, stabilizers for improving thermal stability, for increasing photostability and for raising hydrolysis resistance and chemicals resistance, agents to counteract thermal decomposition, and in particular the lubricants useful for producing moldings. These other additives may be metered in at any stage of the production process, but preferably at an early juncture in order to make early use of the stabilizing effects (or other specific effects) of the additive. Heat stabilizers or oxidation inhibitors are usually metal halides (chlorides, bromides or iodides) derived from metals of Group I of the Periodic Table of the Elements (for example Li, Na, K or Cu).

Other suitable stabilizers are the usual hindered phenols, or else vitamin E and/or compounds of similar structure. HALS stabilizers (hindered amine light stabilizers), benzophenones, resorcinols, salicylates, benzotriazoles and other compounds are also suitable, an example of a benzotriazole being TinuvinRP (UV absorber 2-(2H-benzotriazol-2-yl)-4-methylphenol from CIBA). These are usually used in amounts of up to 2% by weight (based on the entire mixture).

Suitable lubricants and mold-release agents are stearic acids, stearyl alcohol, stearates and/or higher fatty acids in general, derivatives of these and corresponding fatty acid mixtures having from 12 to 30 carbon atoms. The amounts of these additions are in the range from 0.05 to 1% by weight.

Other possible additives are silicone oils, oligomeric isobutylene or similar substances, usually in amounts of from 0.05 to 5% by weight. It is also possible to use pigments, dyes and color brighteners, such as ultramarine blue, phthalocyanines, titanium dioxide, cadmium sulfides and derivatives of perylenetetracarboxylic acid.

Processing aids and stabilizers, such as UV stabilizers, lubricants and antistats, are usually used in amounts of from 0.01 to 5% by weight.

The layer (1) may be produced by processes known per se, by mixing the components. It can be advantageous to premix individual components. It is also possible to mix the components in solution and remove the solvents.

Examples of suitable organic solvents are chlorobenzene, mixtures of chlorobenzene and methylene chloride, and mixtures made from chlorobenzene or from aromatic hydrocarbons, e.g. toluene.

An example of the method of evaporating the solvent mixtures is to use vented extruders.

Any of the known mixing methods may be used to mix the, for example dry, components. However, the mixing preferably takes place by extruding, kneading, or rolling the components together, preferably at from 180 to 400° C., the components having been isolated in advance if necessary from the solution obtained during the polymerization or from the aqueous dispersion.

The components here may be metered in together or separately/in succession.

Layer (2)

Layer (2) is a coloring layer or intermediate layer. One embodiment of the invention provides a molding encompassing a composite layered sheet or composite layered film made from a substrate layer (1) as described above, an outer layer (3), and, between these, an intermediate layer (2) composed of impact-resistant PMMA, polycarbonate, or styrene (co)polymers, such as SAN, which may have been impact-modified, for example ASA or ABS, or of a mixture of these polymers, with the proviso that layer (2) does not have the same structure or makeup as layer (1) on the one hand or as layer (3) on the other hand.

If polycarbonate is used as intermediate layer (2), it is possible to use the polycarbonate described in layer (1), component C.

Impact-resistant PMMA (high impact PMMA: HI-PMMA) is a polymethyl methacrylate which has been rendered impact-resistant by suitable additives. Examples of suitable impact-modified PMMA are described by M. Stickler, T. Rhein in Ullmann's encyclopedia of industrial chemistry Vol. A21, pp. 473-486, VCH Publishers Weinheim, 1992, and H. Domininghaus, Die Kunststoffe and ihre Eigenschaften [Plastics and their properties], VDI-Verlag Düsseldorf, 1992. The intermediate layer (2) may comprise colorants, for example dyes or pigments. These dyes or pigments may be organic or inorganic compounds.

Layer (3)

In general, any of the polymers with comparatively good weathering resistance, transparency, and/or scratch resistance is suitable for forming the outer layer (3) of the inventive moldings.

One embodiment of layer (3) of the inventive moldings encompassing composite layered sheets or composite layered films is an outer layer comprising PMMA. The PMMA used preferably has a number-average molecular weight of from 40 000 to 100 000. Examples of suitable PMMA molding compositions are Lucryl® R G88 or G87 from Resart/BASF, and the compositions described in EP-A2-0 225 500.

In another embodiment, layer (3) is an outer layer comprising one or more hard copolymers, obtainable by polymerizing vinylaromatic monomers and acrylonitrile, the vinylaromatic monomers used comprising from 80 to 100% by weight, preferably from 90 to 100% by weight, particularly preferably from 95 to 100% by weight, of α-methylstyrene and from 0 to 20% by weight, preferably from 0 to 10% by weight, particularly preferably from 0 to 5% by weight, of styrene. Outer layers (3) composed of this material have good scratch resistance, for example as can be determined by the AMTEC-Kistler test.

In another embodiment, layer (3) is an outer layer comprising polycarbonate, in particular polycarbonates containing units which derive from resorcinol esters or from alkylresorcinol esters, for example those described in WO 00/61664, WO 00/15718, or WO 00/26274. These polycarbonates are marketed by General Electric Company with the trademark SollX®, for example.

The thickness of the above composite layered sheets or composite layered films is preferably from 100 μm to 10 mm. The composite layered sheets here particularly preferably have a thickness of from 2 to 10 mm. Composite layered films particularly preferably have a thickness of from 100 to 2000 μm, in particular from 800 to 1500 μm.

In one preferred embodiment of the invention, the composite layered sheets or composite layered films are composed solely of a substrate layer (1), and are therefore monosheets or monofilms. In this case, the thickness of the composite layered sheets or composite layered films is preferably from 100 μm to 10 mm, particularly preferably from 100 μm to 1 mm, in particular from 900 to 1500 μm.

In another preferred embodiment of the invention, the composite layered sheets or composite layered films are composed of a substrate layer (1) and of an outer layer (3). Composite layered sheets or composite layered films made from a substrate layer (1) and an outer layer (3) preferably have the following thicknesses: substrate layer (1) from 70 μm to 9.7 mm, preferably from 80 μm to 2 mm, particularly preferably from 95 μm to 1.5 mm; outer layer (3) from 5 to 300 μm, preferably from 20 to 100 μm, particularly preferably from 30 to 70 μl.

In another preferred embodiment of the invention, the composite layered sheets or composite layered films are composed of a substrate layer (1), an intermediate layer (2), and an outer layer (3). Composite layered sheets or composite layered films made from a substrate layer (1), an intermediate layer (2), and an outer layer (3) preferably have the following thicknesses: substrate layer (1) from 45 μm to 9.2 mm, preferably from 80 μm to 2 mm, particularly preferably from 95 μm to 1.5 mm; intermediate layer (2) from 50 to 500 μm, preferably from 200 to 400 μm, particularly preferably from 250 to 350 μm; outer layer (3) from 5 to 300 μm, preferably from 20 to 100 μm, particularly preferably from 30 to 70 μl.

In one preferred embodiment, the material forming the substrate layer (1) of the composite layered sheets or composite layered films present in the moldings of the invention has a Vicat softening point (Vicat B measured to DIN 53 460 with a temperature rise of 50 K/h) of at least 105° C., preferably at least 108° C. In one preferred embodiment, the composite layered sheets or composite layered films present in the moldings of the invention have a modulus of elasticity Eₜ (measured to ISO 527-2/1B at 5 mm/min and 90° C.) of at least 1300 MPa, preferably at least 1400 MPa, and a modulus of elasticity Eₜ (measured to ISO 527-2/1B at 5 mm/min and 100° C.) of at least 900 MPa, preferably at least 950 MPa, and a Shore C hardness (measured to DIN 53505 at 90° C.) of at least 70, preferably at least 80, particularly preferably at least 90, very particularly preferably at least 100, and a Shore C hardness (measured to DIN 53505 at 100° C.) of at least 60, preferably at least 70, particularly preferably at least 80, very particularly preferably at least 90.

These physical properties are generally advantageous when there is a need for moldings encompassing composite layered sheets or composite layered films which are intended to have good surface quality extending to high temperatures, in particular a low degree of unevenness, even if the composite layered sheets or composite layered films are produced using polymer components other than those described under components A, B and C.

Three-layer sheets or three-layer films may be produced, for example, from a composite layered film with 2 layers (2) and (3), by providing these with a substrate layer (1). They may be produced by the process described below. It is advantageous here for the ratio of the magnitude of the MFI (melt flow index) values of the individual layers of the composite layered sheets or composite layered films to be not more than 3:1, particularly preferably not more than 2:1. This means that the greatest MFI value of one of the layers (1), (2), and (3), to the extent that they are present in the particular composite layered sheets or composite layered films, is not more than three times, particularly preferably not more than twice, the lowest MFI value. This ensures uniform flow behavior of all of the components used in the composite layered sheets or composite layered films. This mutually balanced flow behavior is particularly advantageous in the production processes described below.

There may be other layers present in the moldings of the invention between backing layer and composite layered sheet or composite layered film, for example an adhesive layer to improve bonding of the substrate layer (1) to plastic injection-molded, foamed, or cast onto the back of the material.

Production process for composite layered sheets or composite layered films

The composite layered sheets or composite layered films of the moldings of the invention may be produced by known processes, for example by adapter extrusion or coextrusion, or mutually superposed lamination of the layers. The individual components here are rendered flowable in extruders and, by way of specific apparatus, brought into contact with one another in such a way as to give the composite layered sheets or composite layered films with the layer sequence described above. For example, the components may be coextruded through a slot die. This process is explained in EP-A2-0 225 500.

They may also be produced by the adapter coextrusion process, as described in Tagungsband der Fachtagung Extrusionstechnik “Coextrusion von Folien” [Proceedings of the conference on extrusion technology, “Coextrusion of films”], Oct. 8/9, 1996, VDI-Verlag Düsseldorf, in particular a contribution from Dr. Netze. This cost-effective process is used in most coextrusion applications.

The composite layered sheets and composite layered films of the invention may also be produced by mutually superposed lamination of films or sheets of the components in a heatable nip. Here, films or sheets of the individual components are first produced. Known processes can be used for this purpose. The desired layer sequence is then produced by appropriate mutual superposition of the films or sheets, and these are then passed through a heatable nip between rolls, and bonded with exposure to pressure and heat to give a composite layered sheet or composite layered film.

In particular for the adapter coextrusion process, it is advantageous to balance the flow properties of the individual components in order to develop uniform layers in the composite layered sheets or composite layered films.

Monofilms for the moldings of the invention may also be coated with suitable thermoformable paints.

Processes for producing the moldings of the invention

The composite layered sheets or composite layered films may be used to produce moldings. The desired moldings can be obtained here. The composite layered sheets or composite layered films are particularly preferably used to produce moldings in which very good surface properties are important, in particular a very low degree of surface unevenness. The surfaces are also very scratch-resistant and firmly bonded, giving reliable prevention of destruction of the surfaces by scratching or peeling. The preferred application sector is therefore moldings for outdoor use. In particular, the composite layered sheets or composite layered films are used to produce motor vehicle components, specifically motor vehicle components for exterior applications in the motor vehicle sector. Examples of possible uses here are the production of wheel surrounds, door panels, bumpers, spoilers, aprons, and also exterior mirrors.

The moldings of the invention are particularly suitable for use in components subject to severe insolation, for example roofs or hoods.

The composite layered sheets or composite layered films are particularly advantageously used to produce moldings of the invention which have been colored, specifically moldings for exterior applications in the vehicle sector.

Moldings made from composite layered sheets or composite layered films which are composed of a substrate layer (1) and, where appropriate, an outer layer (3) intrinsically have the very good surface properties listed above. To produce colored moldings, the substrate layer and, where appropriate, the outer layer can be colored with colorants, such as dyes or pigments. A particularly advantageous method of producing-colored moldings is the use of composite layered sheets with three layers. It is sufficient here for only the intermediate layer (2) to be colored. Any of the suitable colorant materials may in turn be used for the coloring process. The outer layer serves here to protect the intermediate layer and to retain the desired surface properties. There is no need here for the bulky substrate layer to be colored, and it is therefore possible to achieve very good coloring with a small amount of colorant materials. Expensive colorant materials may therefore also be used, since their concentration can remain low. In particular when the intermediate layer used comprises HI-PMMA, polycarbonate and/or transparent styrene copolymers, such as Luran® from BASF Aktiengesellschaft, it is possible to achieve depth effects (flop effects). All other types of specific coloring are also possible, examples being metallic colorings and special-effect colorings.

Known processes can be used to produce moldings of the invention from the composite layered sheets or composite layered films. The composite layered sheets or composite layered films may be reverse coated by an injection-molding, foaming, or casting process, without using any other stage in the process, or else they may be subjected to a prior thermoforming process. For example, composite layered sheets or composite layered films with the three-layer structure made from substrate layer, intermediate layer, and outer layer, or with the two-layer structure made from substrate layer and outer layer, or with the monolayer structure made from substrate layer, can be shaped by thermoforming. Use may be made here of either positive or negative thermoforming processes. These processes are known to the skilled worker. This thermoforming process stretches the composite layered sheets or composite layered films. The gloss or surface quality of the composite layered sheets or composite layered films does not decrease with stretching at high stretching ratios, for example up to 1:5, and thermoforming processes are therefore not subject to any major restrictions with regard to the amount of stretching which can be achieved.

The moldings of the invention can be produced from the composite layered sheets or composite layered films, where appropriate after a thermoforming process, by injection molding, foaming, or casting material onto the back of the sheets or films. These processes are known to the skilled worker and are described by way of example in DE-A1 100 55 190 or DE-A1 199 39 111.

The moldings of the invention are obtained by the injection-molding, foaming, or casting of a plastic onto the back of the composite layered films. The plastics used for the process of injection-molding or casting onto the back of the material preferably comprise thermoplastic molding compositions based on ASA polymers or on ABS polymers, on SAN polymers, on poly(meth)acrylates, on polyether sulfones, on polybutylene terephthalate, on polycarbonates, polypropylene (PP), or polyethylene (PE), and blends made from ASA polymers or ABS polymers and polycarbonates, or polybutylene terephthalate, and blends made from polycarbonates and polybutylene terephthalate. Clearly, if PE and/or PP is used here, the substrate layer may be provided in advance with an adhesive layer (O). Amorphous thermoplastics or blends of these are particularly suitable. The plastic used for injection-molding onto the back of the material preferably comprises ABS polymers or SAN polymers. In one preferred embodiment, these are glass-fiber-reinforced plastics, and in particular DE-A1 100 55 190 describes suitable variants. For foaming onto the back of the material it is preferable to use polyurethane foams, for example those described in DE-A1 199 39 111.

The invention is described below in more detail, using examples.

The following materials were produced or purchased (all “parts” are parts by weight):

Elastomeric Graft Copolymer P1-A (Corresponding to Component A):

(a1) 16 parts of butyl acrylate and 0.4 part of tricyclodecenyl acrylate were heated to 60° C. with stirring in 150 parts of water with addition of 1 part of the sodium salt of a C₁₂-C₁₈ paraffinsulfonic acid, 0.3 part of potassium persulfate, 0.3 part of sodium hydrogencarbonate and 0.15 part of sodium pyrophosphate. 10 minutes after the polymerization reaction had begun, a mixture of 82 parts of butyl acrylate and 1.6 parts of tricyclodecenyl acrylate was added within a period of 3 hours. After monomer addition had ended, the reaction was allowed to continue for a further hour. The resultant latex of the crosslinked butyl acrylate polymer had a solids content of 40% by weight. The median particle size (ponderal median) was determined as 76 nm. The particle size distribution was narrow (quotient Q=0.29).
(a2) 150 parts of the polybutyl acrylate latex obtained in (a1) were mixed with 40 parts of a mixture of styrene and acrylonitrile (weight ratio 75:25) and 60 parts of water, and heated at 65° C. for 4 hours with stirring after adding a further 0.03 part of potassium persulfate and 0.05 part of lauroyl peroxide. After the graft copolymerization had ended, the polymerization product was precipitated by means of a gap mixer (described in WO 00/32376), washed with water and dried in a stream of warm air. The degree of grafting of graft copolymer P1-A was 35%.
   Elastomeric Graft Copolymer P2-A (Corresponding to Component a):
(a1) 50 parts of water and 0.1 part of potassium persulfate were added to 2.5 parts of the latex prepared in step (a1) in the preparation of P1-A. A mixture of 49 parts of butyl acrylate and 1 part of tricyclodecenyl acrylate and, secondly, a solution of 0.5 part of the sodium salt of a C₁₂-C₁₈ paraffinsulfonic acid in 25 parts of water were then fed in at 60° C. over the course of 3 hours. After the feed had ended, polymerization was continued for 2 hours. The resultant latex of the crosslinked butyl acrylate polymer had a solids content of 40%. The median particle size (ponderal median of the latex) was determined as 288 nm. The particle size distribution was narrow (Q=0.1).
(a2) 150 parts of this latex were mixed with 40 parts of a mixture of styrene and acrylonitrile (ratio 75:25) and with 110 parts of water, and heated at 65° C. for 4 hours with stirring after addition of a further 0.03 part of potassium persulfate and 0.05 part of lauroyl peroxide. The polymerization product obtained in the graft copolymerization was then precipitated by means of a gap mixer (described in WO 00/32376), separated off, washed with water and dried in a stream of warm air. The degree of grafting of graft copolymer P2-A was determined as 27%.
   Hard Copolymer P1-S-B:

A monomer mixture made from styrene and acrylonitrile was polymerized in solution under conventional conditions. The resultant styrene-acrylonitrile copolymer had an acrylonitrile content of 35% by weight and a viscosity number of 80 ml/g.

Hard Copolymer P2-S-B:

A monomer mixture made from styrene and acrylonitrile was polymerized in solution under conventional conditions. The resultant styrene-acrylonitrile copolymer had an acrylonitrile content of 19% by weight and a viscosity number of 70 ml/g.

Hard Copolymer P1-M-B:

A monomer mixture made from α-methylstyrene and acrylonitrile was polymerized in solution under conventional conditions. The resultant α-methylstyrene-acrylonitrile copolymer had an acrylonitrile content of 30% by weight and a viscosity number of 57 ml/g.

PC:

A commercially available polycarbonate based on bisphenol A, Makrolon® 2800 from Bayer AG.

PMMA:

A commercially available polymethyl methacrylate, Lucryl® G87E from BASF Aktiengesellschaft.

Composite layered sheets or composite layered films F1-F8 with the structure given below were produced from the materials mentioned, each of the polymer components for the individual layers (1) and, where appropriate, (2) and, where appropriate (3) being melted and homogenized in a separate single-screw extruder at from 220 to 260° C. The melt streams were mutually superposed in a feed block prior to entry into the slot die, and stretched and coextruded to the width (1.2 m) of the die in the form of a layered composite:

| | |
|---|---|
| F1: (for comparison) | |
| Substrate layer (1): | layer of thickness 1 mm of a polymer |
| | composition made from 21 parts of P1-A, |
| | 11 parts of P2-A, 45 parts of P1-S-B and |
| | 23 parts of P1-M-B. |
| F2: | |
| Substrate layer (1): | layer of thickness 1 mm of a polymer |
| | composition made from 31 parts of P2-A, |
| | 21 parts of P1-S-B and 48 parts of P1-M-B. |
| F3: | |
| Substrate layer (1): | layer of thickness 1 mm of a polymer |
| | composition made from 31 parts of P2-A, |
| | 21 parts of P1-S-B and 48 parts of P1-M-B. |
| Outer layer (3): | layer of thickness 80 μm made from PMMA |
| F4: | |
| Substrate layer (1): | layer of thickness 1 mm of a polymer |
| | composition made from 31 parts of P2-A and |
| | 69 parts of P1-M-B. |
| F5: | |
| Substrate layer (1): | layer of thickness 1 mm of a polymer |
| | composition made from 31 parts of P2-A and |
| | 69 parts of P1-M-B. |
| Outer layer (3): | layer of thickness 80 μm made from PMMA |
| F6: (for comparison) | |
| Substrate layer (1): | layer of thickness 1.3 mm of a polymer |
| | composition made from 10 parts of P1-A, |
| | 9 parts of P2-A, 21 parts of P1-S-B and |
| | 60 parts of PC. |
| Outer layer (3): | layer of thickness 150 μm made from PMMA |
| F7: (for comparison) | |
| Substrate layer (1): | layer of thickness 1.3 mm of a polymer |
| | composition made from 10 parts of P1-A, |
| | 9 parts of P2-A, 21 parts of P1-S-B and |
| | 60 parts of PC. |
| Outer layer (3): | layer of thickness 300 μm made from PMMA |
| F8: | |
| Substrate layer (1): | layer of thickness 1 mm of a polymer |
| | composition made from 18 parts of P2-A, |
| | 22 parts of P2-S-B, 25 parts of P1-M-B, |
| | and 35 parts of PC. |

The composite layered sheets or composite layered films F1-F8 were subjected to flame application by applying a flame to the composite layered sheets or composite layered films at a uniform rate, in a flame-application machine using a multiflame burner with a roaring blue, reducing flame (propane gas, about 1300° C.). The flame-application to the composite layered sheets or composite layered films was restricted to the side to be foamed.

Each of the flame-treated composite layered sheets or composite layered films was then placed for further processing in an opened mold in the lower mold section of a long-fiber-injection (LFI) plant from Krauss Maffei, the lower mold section having been heated to about 36-45° C.

Once the composite layered sheets or composite layered films had been inserted, the lower mold section was brought to the foaming position, and the upper mold section was treated with release agent.

The upper mold section was temperature-controlled at from 40 to 65° C.

The natural fibers or glass fibers wetted with polyurethane (PU) were input in programmed curved paths by a robot, using the LFI mixing head and the associated fiber-cutting system.

The PU system used comprised Elastoflex® E 3509 (Elastogran GmbH), which comprised from 10 to 40% by weight of glass fibers.

The input time was from 20 to 30 s.

Once the input of the PU-wetted glass fibers had ended, the mold was closed.

Once the reaction time of 180 s had expired, the mold was opened and the resultant molding was demolded. The thickness of the PU foam was 7 mm.

Each of the moldings produced in this way was aged for 24 h at room temperature and then for 1 h at 105° C.

Each of the moldings T1-T8 produced from the composite layered sheets or composite layered films F1-F8 by applying foam to the back of the material, using the process described, was evaluated visually for surface quality. These results are given in table 1 below.

In addition, table 1 gives the Vicat softening points (Vicat B measured to DIN 53 460 with a temperature rise of 50 K/h) of the material of which the respective substrate layers (1) of the composite layered sheets or composite layered films F1-F8 is composed, this being a measure of heat resistance.

Table 1 also shows the moduli of elasticity Eₜ at 90° C. and 100° C. (measured to ISO 527-2/1B at 5 mm/min), and at 23° C. (measured to ISO 527-2/1B at 50 mm/min), determined on the respective composite layered sheets or composite layered films F1-F8.

TABLE 1

| | | Vicat B | | | | |
|---|---|---|---|---|---|---|
| | | temperature | Eₜ at 23° C. | Eₜ at 90° C. | Eₜ at 100° C. | |
| Example | Molding | [° C.] | [MPa] | [MPa] | [MPa] | Surface quality |
| 1 c | T1 | 104 | 2454 | 1475 | 979 | marked unevenness |
| 2 | T2 | 108 | 2455 | 1549 | 1181 | very little unevenness |
| 3 | T3 | 108 | 2450 | 1523 | 954 | very little to |
| | | | | | | moderate unevenness |
| 4 | T4 | 111 | 2455 | 1544 | 1193 | very little unevenness |
| 5 | T5 | 111 | 2450 | 1484 | 1084 | very little to |
| | | | | | | moderate unevenness |
| 6 c | T6 | 120 | 2300 | 1275 | 1080 | moderate unevenness |
| 7 c | T7 | 120 | 2300 | 962 | 721 | moderate to |
| | | | | | | marked unevenness |
| 8 | T8 | 115 | 2500 | 1590 | 1250 | very little unevenness |

The examples indicated by “c” are non-inventive and serve for comparison.

The examples confirm that, in comparison with known moldings having comparable or greater thickness of the composite layered sheet or composite layered film and having comparable or higher heat resistance of the material forming the substrate layer, the moldings of the invention have improved surface quality at high temperatures, in particular less unevenness.

1-11. (canceled)

12. A molding encompassing a composite layered sheet or composite layered film and a backing layer made from plastic injection-molded, foamed, or cast onto the back of the material, where the composite layered sheet or composite layered film encompasses
(1) a substrate layer comprising, based on the total of the amounts of components A and B, and, where appropriate, C and/or D, which give 100% by weight in total,
a from 1 to 99% by weight of an elastomeric graft copolymer as component A,
b from 1 to 99% by weight of one or more hard copolymers containing units which derive from vinylaromatic monomers, as component B,
c from 0 to 80% by weight of polycarbonates, as component C, and
d from 0 to 50% by weight of fibrous or particulate fillers, or a mixture of these, as component D,
wherein component B contains, based on the total weight of units deriving from vinylaromatic monomers, from 40 to 100% by weight of units deriving from α-methylstyrene and from 0 to 60% by weight of units deriving from styrene,
(2) if appropriate, an intermediate layer, and
(3) an outer layer comprising one or more hard copolymers, obtainable via polymerization of vinylaromatic monomers and acrylonitrile, where the vinylaromatic monomers used comprise from 80 to 100% by weight of α-methylstyrene and from 0 to 20% by weight of styrene.

13. The molding as claimed in claim 12, wherein component A encompasses
a1 from 1 to 99% by weight of a particulate graft base as component A1, obtainable by polymerizing, based on A1,
a11 from 80 to 99.99% by weight of at least one C₁-C₈-alkyl acrylate, as component A11,
a12 from 0.01 to 20% by weight of at least one polyfunctional crosslinking monomer, as component A12,
a2 from 1 to 99% by weight of a graft A2 obtainable by polymerizing, based on A2,
a21 from 40 to 100% by weight of styrene, of a substituted styrene, or of a (meth)acrylate, or of a mixture of these, as component A21, and
a22 Up to 60% by weight of acrylonitrile or methacrylonitrile, as component A22,
where the graft A2 is composed of at least one graft shell, and the graft copolymer has a median particle size of from 50 to 1000 nm,
and component B encompasses copolymers of
b1 from 40 to 100% by weight of vinylaromatic monomers, as component B1,
a21 from 40 to 100% by weight of styrene, of a substituted styrene, or of a (meth)acrylate, or of a mixture of these, as component A21, and
a22 Up to 60% by weight of acrylonitrile or methacrylonitrile, as component A22,
where the graft A2 is composed of at least one graft shell, and the graft copolymer has a median particle size of from 50 to 1000 nm,
and component B encompasses copolymers of
b1 from 40 to 100% by weight of vinylaromatic monomers, as component B 1,
b2 up to 60% by weight of acrylonitrile or methacrylonitrile, as component B2.

14. The molding as claimed in claim 12, wherein component A encompasses
a1′ from 10 to 90% by weight of at least one elastomeric graft base with a glass transition temperature below 0° C., as component A1′, obtainable by polymerizing, based on A1′,
a11′ from 60 to 100% by weight of at least one conjugated diene, as component A11′,
a12′ from 0 to 30% by weight of at least one monoethylenically unsaturated monomer, as component A12′, and
a13′ from 0 to 10% by weight of at least one crosslinking monomer having unconjugated double bonds, as component A13′,
a2′ from 10 to 60% by weight of a graft, as component A2′, made from, based on A2′,
a21′ from 50 to 100% by weight of at least one vinylaromatic monomer, as component A21′
a22′ from 5 to 35% by weight of acrylonitrile and/or methacrylonitrile, as component A22′
a23′ from 0 to 50% by weight of at least one other monoethylenically unsaturated monomer, as component A23′,
and component B encompasses copolymers of
b1′ from 50 to 100% by weight of vinylaromnatic monomers, as component B1′,
b2′ from 0 to 50% by weight of acrylonitrile or methacrylonitrile or a mixture of these, as component B2′,
b3′ from 0 to 50% by weight of at least one other monoethylenically unsaturated monomer, as component B3′.

15. The molding as claimed in claim 12, wherein the composite layered sheet or composite layered film encompasses
(1) a substrate layer,
(3) an outer layer, and
(2) an intermediate layer located between substrate layer and outer layer and differing from these, comprising impact-modified polymethyl methacrylate, polycarbonate, or styrene (co)polymers.

16. The molding as claimed in claim 12, wherein the composite layered sheet or composite layered film has a thickness of from 100 μm to 10 mm.

17. The molding as claimed in claim 12, wherein
the material forming the substrate layer (1) of the composite layered sheet or of the composite layered film has a Vicat softening point (Vicat B measured to DIN 53 460 with a temperature rise of 50° K/h) of at least 105° C., and
the composite layered sheet or composite layered film has
a modulus of elasticity Eₜ (measured to ISO 527-2/1B at 5 mm/min and 90° C.) of at least 1300 MPa,
a modulus of elasticity Eₜ (measured to ISO 527-2/1B at 5 mm/min and 100° C.) of at least 900 MPa,
a Shore C hardness (measured to DIN 53505 at 90° C.) of at least 70, and
a Shore C hardness (measured to DIN 53505 at 100° C.) of at least 60.

18. The process for producing moldings as claimed in claim 12, which comprises producing the composite layered sheets or composite layered films by adapter extrusion or coextrusion, or mutually superposed lamination of the layers (1) and, where appropriate, (2) and/or (3), and, where appropriate, then thermoforming and finally injection-molding, foaming or casting plastic onto the back of the sheets or films.

19. The use of moldings as claimed in claim 12 as bodywork components for motor vehicles.

20. A roof, a door, an engine cover, a trunk lid, a spoiler, a wind deflector, a lateral airfoil, or a bumper for motor vehicles, comprising a molding as claimed in claim 12.

21. The molding as claimed in claim 13, wherein the composite layered sheet or composite layered film encompasses
(1) a substrate layer,
(3) an outer layer, and
(2) an intermediate layer located between substrate layer and outer layer and differing from these, comprising impact-modified polymethyl methacrylate, polycarbonate, or styrene (co)polymers.

22. The molding as claimed in claim 14, wherein the composite layered sheet or composite layered film encompasses
(1) a substrate layer,
(3) an outer layer, and
(2) an intermediate layer located between substrate layer and outer layer and differing from these, comprising impact-modified polymethyl methacrylate, polycarbonate, or styrene (co)polymers.

23. The molding as claimed in claim 13, wherein the composite layered sheet or composite layered film has a thickness of from 100 μm to 10 mm.

24. The molding as claimed in claim 14, wherein the composite layered sheet or composite layered film has a thickness of from 100 μm to 10 mm.

25. The molding as claimed in claim 15, wherein the composite layered sheet or composite layered film has a thickness of from 100 μm to 10 mm.

26. The molding as claimed in claim 13, wherein
the material forming the substrate layer (1) of the composite layered sheet or of the composite layered film has a Vicat softening point (Vicat B measured to DIN 53 460 with a temperature rise of 50° K/h) of at least 105° C., and
the composite layered sheet or composite layered film has
a modulus of elasticity Eₜ (measured to ISO 527-2/1B at 5 mm/min and 90° C.) of at least 1300 MPa,
a modulus of elasticity Eₜ (measured to ISO 527-2/1B at 5 mm/min and 100° C.) of at least 900 MPa,
a Shore C hardness (measured to DIN 53505 at 90° C.) of at least 70, and
a Shore C hardness (measured to DIN 53505 at 100° C.) of at least 60.

27. The molding as claimed in claim 14, wherein
the material forming the substrate layer (1) of the composite layered sheet or of the composite layered film has a Vicat softening point (Vicat B measured to DIN 53 460 with a temperature rise of 50° K/h) of at least 105° C., and
the composite layered sheet or composite layered film has
a modulus of elasticity Eₜ (measured to ISO 527-2/1B at 5 mm/min and 90° C.) of at least 1300 MPa,
a modulus of elasticity Eₜ (measured to ISO 527-2/1B at 5 mm/min and 100° C.) of at least 900 MPa,
a Shore C hardness (measured to DIN 53505 at 90° C.) of at least 70, and
a Shore C hardness (measured to DIN 53505 at 100° C.) of at least 60.

28. The molding as claimed in claim 15, wherein
the material forming the substrate layer (1) of the composite layered sheet or of the composite layered film has a Vicat softening point (Vicat B measured to DIN 53 460 with a temperature rise of 50° K/h) of at least 105° C., and
the composite layered sheet or composite layered film has
a modulus of elasticity Eₜ (measured to ISO 527-2/1B at 5 mm/in and 90° C.) of at least 1300 MPa,
a modulus of elasticity Eₜ (measured to ISO 527-2/1B at 5 mm/min and 100° C.) of at least 900 MPa,
a Shore C hardness (measured to DIN 53505 at 90° C.) of at least 70, and
a Shore C hardness (measured to DIN 53505 at 100° C.) of at least 60.

29. The molding as claimed in claim 16, wherein
the material forming the substrate layer (1) of the composite layered sheet or of the composite layered film has a Vicat softening point (Vicat B measured to DIN 53 460 with a temperature rise of 50° K/h) of at least 105° C., and
the composite layered sheet or composite layered film has
a modulus of elasticity Eₜ (measured to ISO 527-2/1B at 5 mm/min and 90° C.) of at least 1300 MPa,
a modulus of elasticity Eₜ (measured to ISO 527-2/1B at 5 mm/min and 100° C.) of at least 900 MPa,
a Shore C hardness (measured to DIN 53505 at 90° C.) of at least 70, and
a Shore C hardness (measured to DIN 53505 at 100° C.) of at least 60.

30. The molding as claimed in claim 17, wherein
the material forming the substrate layer (1) of the composite layered sheet or of the composite layered film has a Vicat softening point (Vicat B measured to DIN 53 460 with a temperature rise of 50° K/h) of at least 105° C., and
the composite layered sheet or composite layered film has
a modulus of elasticity Eₜ (measured to ISO 527-2/1B at 5 mm/min and 90° C.) of at least 1300 MPa,
a modulus of elasticity Eₜ (measured to ISO 527-2/1B at 5 mm/min and 100° C.) of at least 900 MPa,
a Shore C hardness (measured to DIN 53505 at 90° C.) of at least 70, and
a Shore C hardness (measured to DIN 53505 at 100° C.) of at least 60.

31. The process for producing moldings as claimed in claim 13, which comprises producing the composite layered sheets or composite layered films by adapter extrusion or coextrusion, or mutually superposed lamination of the layers (1) and, where appropriate, (2) and/or (3), and, where appropriate, then thermoforming and finally injection-molding, foaming or casting plastic onto the back of the sheets or films.
